(19) United States
(12) Patent Application Publication
(10) Pub. No.: US 2013/0100295 A1
(43) Pub. Date: Apr. 25, 2013

(54) INFORMATION PROCESSING APPARATUS AND METHOD

(71) Applicant: TOSHIBA TEC KABUSHIKI KAISHA, Tokyo (JP)

(72) Inventors: Hidehiro Naito, Shizuoka-ken (JP); Hiroshi Sugasawa, Miyagi-ken (JP)

(73) Assignee: TOSHIBA TEC KABUSHIKI KAISHA, Tokyo (JP)

(21) Appl. No.: 13/653,494

(22) Filed: Oct. 17, 2012

(30) Foreign Application Priority Data
Oct. 19, 2011 (JP) 2011-230091

(51) Int. Cl. H04N 5/225

(52) U.S. Cl. 348/169; 348/E05.024

(57) ABSTRACT

An information processing apparatus includes an acquirement section, a detection section, a selection section, a display control section and a commodity recognition section. The acquirement section acquires an image captured by an image capturing section. The detection section detects all or part of targets included in the image acquired by the acquirement section. The selection section selects any one target in the condition that the detection section detects a plurality of targets. The display control section displays the target selected by the selection section in the plurality of targets on the image acquired by the acquirement section. The commodity recognition section recognizes a commodity captured by the image capturing section based on a similarity showing a degree with which all or part of the images of the target selected by the selection section are similar to the reference image of each commodity.

### CROSS-REFERENCE TO RELATED APPLICATION

This application is based upon and claims the benefit of priority from Japanese Patent Application No. 2011-230091, filed Oct. 19, 2011, the entire contents of which are incorporated herein by reference.

### FIELD

Embodiments described herein relate to an information processing apparatus and a method.

### BACKGROUND

Formerly, a generic object recognition technology extracted the characteristic quantity of a target from the image data of a captured article and recognized (detected) the category and the like of the article by comparing the characteristic quantity with previously prepared contrast data (characteristic quantity). Moreover, a store system was provided, the generic object recognition technology was used for the recognition of a commodity such as a vegetable, a fruit and the like, and a sales registration was carried out on the recognized commodity.

### BRIEF DESCRIPTION OF THE DRAWINGS

FIG. 1 is a perspective drawing showing an example of a checkout system (store system) according to the present embodiment;

FIG. 2 is a block diagram showing the hardware components of a POS terminal and a commodity reading apparatus;

FIG. 3 is a conceptual graph exemplifying showing the data structure of a PLU file;

FIG. 4 is a block diagram showing functional components of a POS terminal and a commodity reading apparatus;

FIG. 5 is a drawing showing an example of a frame image acquired by an image acquirement section;

FIG. 6 is an explanatory drawing of a method selecting one image region based on the apex position of the image region;

FIG. 7 is an explanatory drawing of a method selecting one image region based on the gravity center position of the image region;

FIG. 8 is a drawing showing an example of displaying a display picture of the selected image region;

FIG. 9 is a drawing showing the other example of displaying the display picture of the selected image region;

FIG. 10 is a drawing showing a picture example when the selected image region is displayed with different luminosities; and

FIG. 11 is a flow chart showing an operations example of the checkout system.

### DETAILED DESCRIPTION

According to one embodiment, an information processing apparatus includes an acquirement section, a detection section, a selection section, a display control section and a commodity recognition section. The acquirement section acquires an image captured by an image capturing section. The detection section detects all or part of targets included in the image acquired by the acquirement section. The selection section selects any one target in the condition that the detection section detects a plurality of targets. The display control section displays the target selected by the selection section in the plurality of targets on the image acquired by the acquirement section. The commodity recognition section recognizes a commodity captured by the image capturing section based on a similarity showing a degree with which all or part of the images of the target selected by the selection section are similar to the reference image of each commodity.

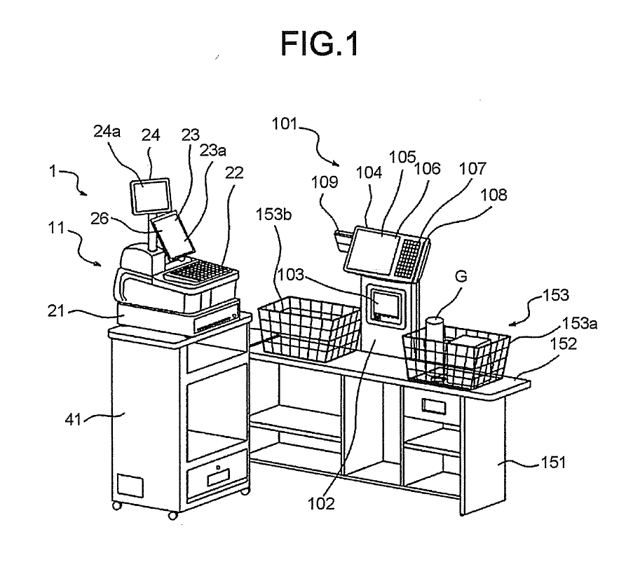

FIG. 1 is a perspective drawing showing an example of a checkout system 1. As shown in FIG. 1, the checkout system 1 comprises a commodity reading apparatus 101 reading the relevant information, of the commodity and a POS terminal 11 carrying out the registration and the check computation of the commodity of one transition. Hereinafter, the example that the commodity reading apparatus 101 is used as the information processing apparatus according to the present embodiment is described. In addition, a same symbol is appended to a same construction shown in a plurality of graphic formulas hereinafter, and further, the repeated description of the same construction is omitted sometimes.

The POS terminal 11 is placed on the upper surface of a cash drawer 21 on a checkout platform 41. The opening operations of a cash drawer 21 is controlled by the POS terminal 11. The upper surface of the POS terminal 11 is equipped with a keyboard 22 pressed down and operated by an operator (salesclerk). Observed from one side of an operator operating the keyboard 22, a display 23 displaying information towards an operator is installed at the more inner side of the keyboard 22. The display 23 displays the information on its display surface 23a. A touch panel 26 is laminated on the display surface 23a. A rotatable display 24 for customer is vertically installed at the innermost side of the display 23. The display 24 for customer displays the information on its display surface 24a. In addition, according to the display 24 for customer shown in FIG. 1, the display surface 24a faces to an approximately front side in FIG. 1, but the display 24 for customer can display the information towards a customer by rotating the display 24 for customer in the format that the display surface 24a faces to the inner side in FIG. 1.

A table-shaped counter 151 having a wide-width is arranged to form an L shape with the checkout counter 41 bearing the POS terminal 11 is placed. A placing surface 152 is formed on the upper surface of the counter 151. A shopping basket 153 containing a commodity G is placed on the placing surface 152. The shopping basket 153 may be distinguished in use to a first shopping basket 153a held by the hands of the customer and a second shopping basket 153b placed at a position opposite to the first shopping basket 153a through the commodity reading apparatus 101. In addition, the shopping basket 153 is not limited to the shape of a basket and also may be a tray and the like. Moreover, the shopping basket 153 (the second shopping basket 153b) is also not limited to the shape of an ordinary basket and further can be box-shaped, bag-shaped and the like.

The commodity reading apparatus 101 connected with the POS terminal 11 in the way of being transmitting data is installed on the placing surface 152 of the counter 151. The commodity reading apparatus 101 comprises a rectangular housing 102 having a relatively thin length. A reading window 103 is arranged at the front surface of the housing 102. A display/operation section 104 is mounted on the upper part of the housing 102. The display/operation section 104 is provided with a display 106, on the surface of which a touch panel 105 is laminated. A keyboard 107 is installed at the right side of the display 106. A card reading slot 108 which is not shown in figures and reads a card is installed on the right side of the keyboard 107. A display 109 for providing the information for the customer is installed at near the left inner side of the back surface of the display/operation section 104 at a position at which the operator operates.

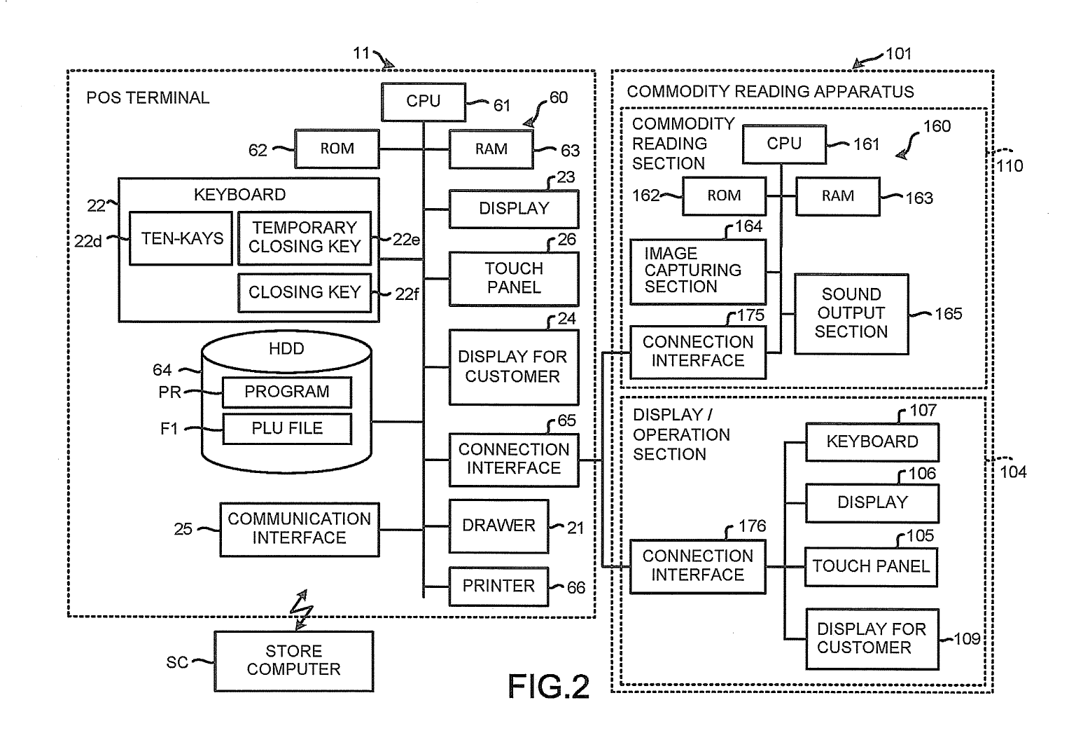

The commodity reading apparatus 101 comprises a commodity reading section 110 (refer to FIG. 2). The commodity reading section 110 is equipped with a image capturing section 164 (refer to FIG. 2) at the inner side of the reading window 103.

The commodity G of one transition is contained in the first shopping basket 153a held by the hands of the customer. The commodity G in the first shopping basket 153a is moved into the second shopping basket 153b by the operator operating the commodity reading apparatus 101. In the movement process, the commodity G is enabled to face to the reading window 103 of the commodity reading apparatus 101. At the moment, the image capturing section 164 (refer to FIG. 2) configured in the reading window 103 shoots the commodity G.

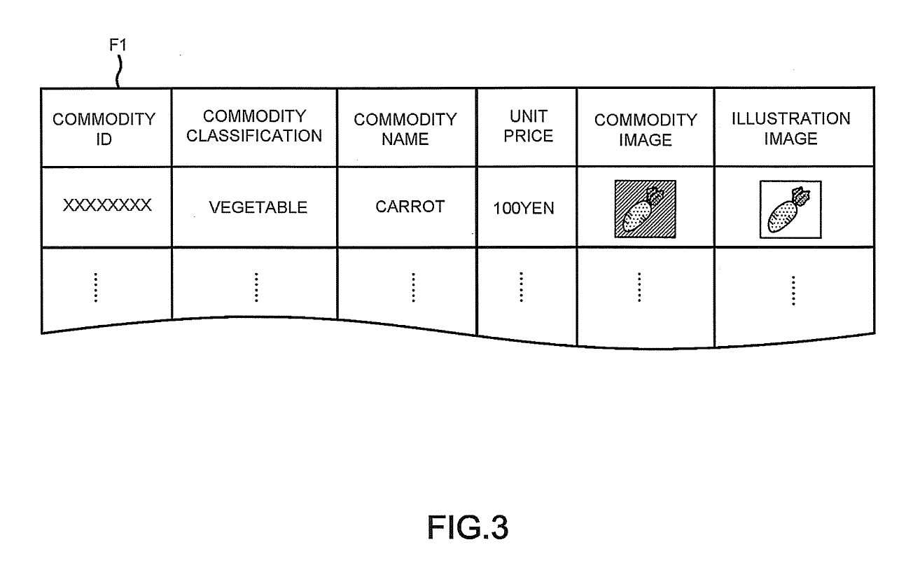

In the commodity reading apparatus 101, a picture for appointing whether or not the commodity G included in the image captured by the image capturing section 164 corresponds to the commodity registered in the following FLU file F1 (refer to FIG. 3) is displayed on the display/operation section 104, and the commodity ID of the appointed commodity is notified to the POS terminal 11. In the POS terminal 11, sales registration information such as the commodity classification, the commodity name, the unit price and the like of the commodity corresponding to the commodity ID is recorded in a sales master file (not shown in the figures) and the like to carry out sales registration based on the commodity ID notified from the commodity reading apparatus 101.

FIG. 2 is a block diagram showing hardware components of the POS terminal 11 and the commodity reading apparatus 101. The POS terminal 11 comprises a microcomputer 60 as an information processing section executing information processing. The microcomputer 60 is formed by connecting an ROM (Read Only Memory) 62 and an RAM (Random Access Memory) 63 onto a CPU (Central Processing Unit) 61 executing all kinds of calculation processing to control all the sections by a bus.

The CPU 61 of the POS terminal 11 is connected with the cash drawer 21, the keyboard 22, the display 23, the touch panel 26 and the display 24 for customer through various input and output circuits (all not shown in the figures). These components are controlled by the CPU 61.

The keyboard 22 includes a numerical keypad 22d, the upper surface of which displays a numeral such as “1”, “2”, “3” . . . and the like and a multiplication operational character such as “x”, a temporary closing key 22e and a closing key 22f.

The CPU 61 of the POS terminal 11 is connected with an HDD 64 (Hard Disk Drive) in which programs and various files are stored in the HDD 64. All or part of the program and the various files stored in the HDD 64 are copied to the RAM 63 and be sequentially executed by the CPU 61 when the POS terminal 11 is activated. An example of the program stored in the HDD 64 is a program PR for processing the sales data of the commodity. An example of the files stored in the HDD 64 is the PLU file F1 which is transmitted from a store computer SC to the POS terminal and stored in the HDD 64.

The PLU file F1 is a commodity file setting the relevancy of the information relevant with the sales registration of the commodity G and the image of the commodity G aiming at each commodity G exhibited and sold in a store.

FIG. 3 is a conceptual graph exemplifying showing the data structure of the PLU file F1. As shown in FIG. 3, the PLU file F1 stores the information relevant with the commodity, such as the uniquely distributed commodity ID, the commodity classification to which the commodity G belongs, the commodity name, the unit price and the like, and the commodity image obtained by capturing the commodity as the commodity information of the commodity G aiming at each commodity G. In addition, the PLU file F1 is formed to be capable of being read out by the commodity reading apparatus 101 through a connection interface 65.

The data structure of the PLU file F1 is not limited to the example in FIG. 3, for instance, the data structure of the PLU file F1 further can be in the form that the characteristic quantity such as a hue, a surface concave-convex status and the like read according to the commodity image is stored aiming at each commodity.

Returning to FIG. 2, the CPU 61 of the POS terminal 11 is connected with a communication interface 25 that is use to perform a data communication with the store computer SC through an input and output circuit (not shown in the figures). The store computer SC is installed in the backyard of a store. The PLU file F1 sent to the POS terminal 11 is stored in an HDD (not shown in the figures) of the store computer Sc.

The CPU 61 of the POS terminal 11 is connected with the connection interface 65 which enables data transmission/reception with the commodity reading apparatus 101. The connection interface 65 is connected with the commodity reading apparatus 101. Moreover, the CPU 61 of the POS terminal 11 is connected with a printer 66 for printing receipts and the like. The POS terminal 11 prints the content of one transition on a receipt under the control of the CPU 61.

The commodity reading apparatus 101 further includes a microcomputer 160. The microcomputer 160 is formed by connecting an ROM 162 and an RAM 163 onto a CPU 161 by a bus line. The programs executed by the CPU 161 are stored in the ROM 162. The CPU 161 is connected with the image capturing section 164 and a sound output section 165 via various input and output circuits (all not shown in the figures). The operations of the image capturing section 164 and the sound output section 165 are controlled by the CPU 161. The display/operation section 104 is connected to the commodity reading section 110 and the POS terminal 11 through a connection interface 176. The operation of the display/operation section 104 is controlled by the CPU 161 of the commodity reading section 110 and the CPU 61 of the POS terminal 11.

The image capturing section 164 is a color CCD image sensor, a color CMOS image sensor and the like, and is the image capturing section carrying out capturing from the reading window 103 under the control of the CPU 161. For instance, the image capturing section 164 carries out the capturing of a 30 fps dynamic image. Frame images (captured images) captured with a fixed frame per second in sequence by the capturing section are stored in the RAM 163.

The sound output section 165 is a sound circuit, a loudspeaker and the like for radiating a preset warning sound and the like. The sound output section 165 informs events by utilizing the warning tone and a sound under the control of the CPU 161.

The CPU 161 is connected with a connection interface 175 which is connected with the connection interface 65 of the POS terminal 11 to transmit data with the POS terminal 11. Moreover, the CPU 161 transmits the data with the display/operation section 104 via the connection interface 175.

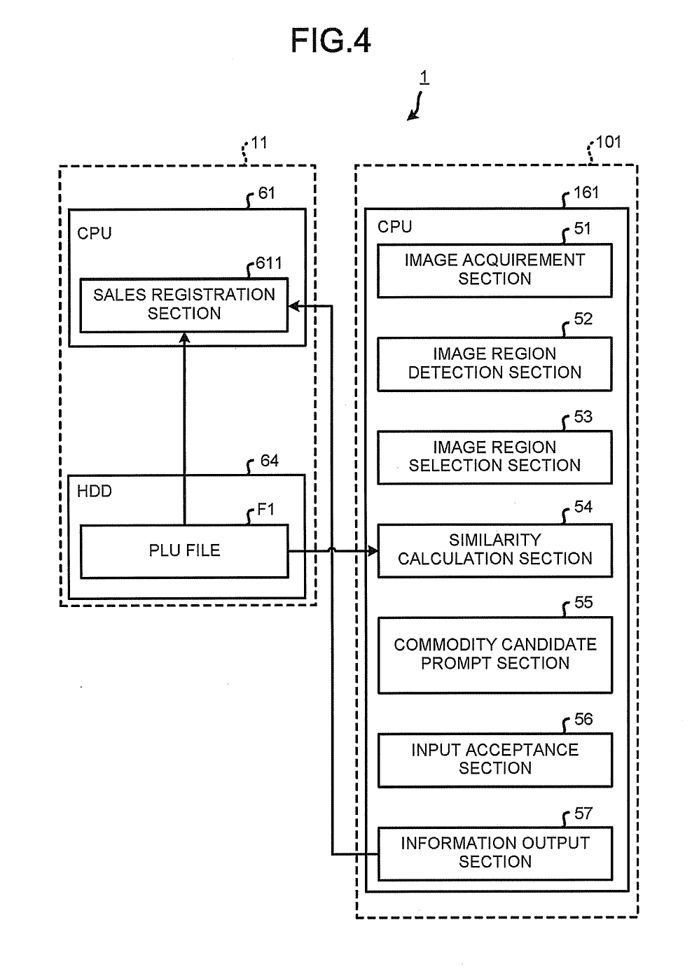

Next, functional components of the CPU 161 and the CPU 61 realized by sequentially executing the programs by the CPU 161 and the CPU 61 are described below with reference to FIG. 4.

FIG. 4 is a block diagram showing functional components of the POS terminal 11 and the commodity reading apparatus 101. As shown in FIG. 4, the CPU 161 of the commodity reading apparatus 101 exerts functions as an image acquirement section 51, an image region detection section 52, an image region selection section 53, a similarity calculation section 54, a commodity candidate prompt section 55, an input acceptance section 56 and an information output section 57 by executing the program stored in the ROM 162. Moreover, similarly, the CPU 61 of the POS terminal 11 exerts the functions as a sales registration section 611 by executing the program PR.

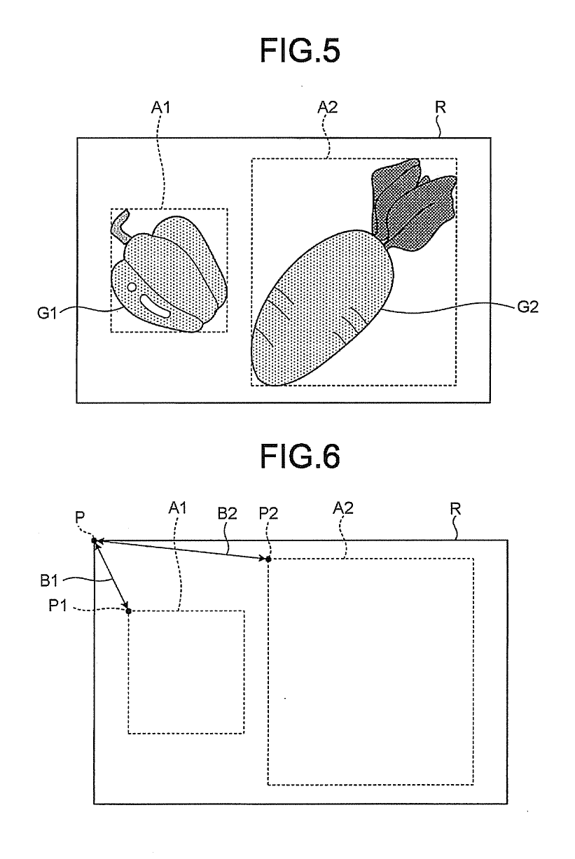

The image acquirement section 51 outputs a capturing-on signal to the image capturing section 164, so that the image capturing section 164 begins a capturing operation. The image capturing section 164 shoots the frame image R (refer to FIG. 5) of a reading region of the image capturing section 164 and stores the frame image R in the RAM 163. The image acquirement section 51 acquires the frame images in the order of the frame images that are sequentially stored the RAM 163.

FIG. 5 is a drawing showing an example of the frame image R acquired by the image acquirement section 51. As shown in FIG. 5, when operator enables the commodity to face to the reading window 103, all or part of the commodities as captured targets can be captured in the reading region of the image capturing section 164. In FIG. 5, in the condition that two commodities G1 and G2 (called as the commodities G if being not limited particularly) are captured as the targets is shown. In addition, in the condition that the target other than the commodity, such as the hand of the operator, and the like, is captured, all or part of the targets are included in the frame image R.

The image region detection section 52 detects (extracts) all or part of the targets included in the frame image R acquired by the image acquirement section 51. More particularly, the image region detection section 52 detects an image region including all or part of the commodities G included in the frame image R by utilizing a pattern matching technology and the like. Particularly, contour lines and the like are extracted according to the images obtained by carrying out binaryzation on the acquired frame images. Subsequently, the contour line extracted from the frame image last time is compared with that extracted from the frame image this time, so as to detect the image region including the target.

In the example in FIG. 5, the image region detection section 52 detects an image region A1 including the commodity G1 and an image region A2 including the commodity G2. In addition, the shape of the image region is not particularly limited, can be a rectangular shape as shown in FIG. 5, also can be other shape such as a circular shape, an elliptical shape and the like, and further can be a shape obtained after these shapes are rotated.

The image region selection section 53 selects any one target in the condition that the image region detection section 52 detects the plurality of targets. More particularly, in the condition that the image region detection section 52 detects a plurality of image regions, the image region selection section 53 selects any one image region based on the positions of the image regions including all or part of the targets (commodities G) in the frame image R.

FIG. 6 is an explanatory drawing of a method selecting one image region based on the apex position of the image region in the present embodiment. The image region selection section 53 selects one image region, and the distance among the apexes P1 and P2 of the top left corners of the image regions A1 and A2 and the top left apex P of the frame image R is nearest. As an example, the image region selection section 53 compares the length of a line segment 31 connecting the apex P with the apex P1 with the length of a line segment 32 connecting the apex P with the apex P2, and selects the image region A1 whose length is shorter.

The positions of the apexes P1 and P2 of the top left corners of the image regions A1 and A2 are compared in the description, but the positions of other parts of the image regions A1 and A2 also can be compared. As the other example, the gravity center positions of the image regions A1 and A2 can be compared.

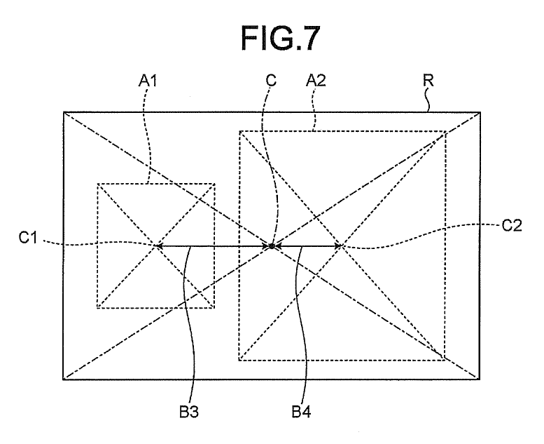

FIG. 7 is an explanatory drawing of a method selecting one image region based on the gravity center position of the image region. In FIG. 7, the condition that the two image regions A1 and A2 with reference to the commodities G1 and G2 are respectively detected is described. The image region selection section 53 selects one image region whose gravity center is nearest the gravity center C of the frame image R. As an example, the image region selection section 53 compares the length of a line segment B3 connecting the gravity center C1 of the image region A1 with the gravity center C of the frame image R with that of a line segment B4 connecting the gravity center C2 of the image region A2 with the gravity center C of the frame image R, and selects one image region with the gravity center nearest the gravity center C. In the example in FIG. 7, the image region selection section 53 selects the image region A2 with the gravity center C2 if judging that the distance of the gravity center C and the gravity center C2 is nearer than that of the gravity center C and the gravity center C1.

In the above description, the mutual position relationship of the image regions is compared based on the apex positions and the gravity center positions, but the position of each image region used when the position relationship is compared is not particularly limited, and one image region also can be selected by utilizing other positions. Moreover, in the description, the position relationship is compared by utilizing the gravity center of the image region, but the gravity center also can be solved for aiming at all or part of the targets included in the image region, so as to compare the position relationship. Moreover, in such a condition, the gravity center of the target further can be solved for based on luminosity and color information in the image region. The image region selection section 53 (display control section) displays the target selected in such a format in the plurality of targets on the frame image R by utilizing a measure such as a frame, a mark and the like. That is, the image region selection section 53 displays the frame including one image region selected in such a format or displays the mark and the like near the target, so as to report the selected target to the operator.

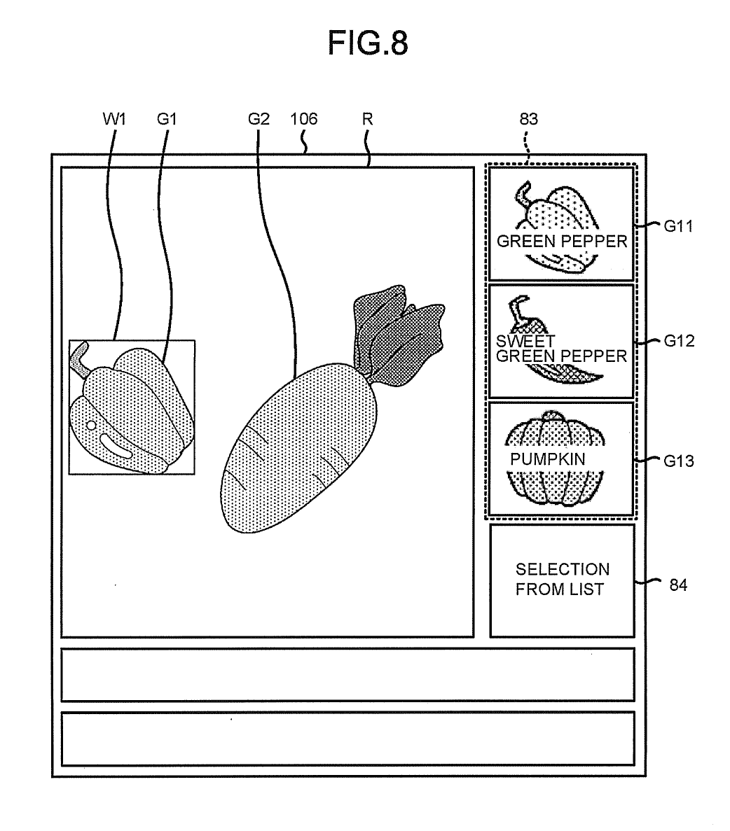

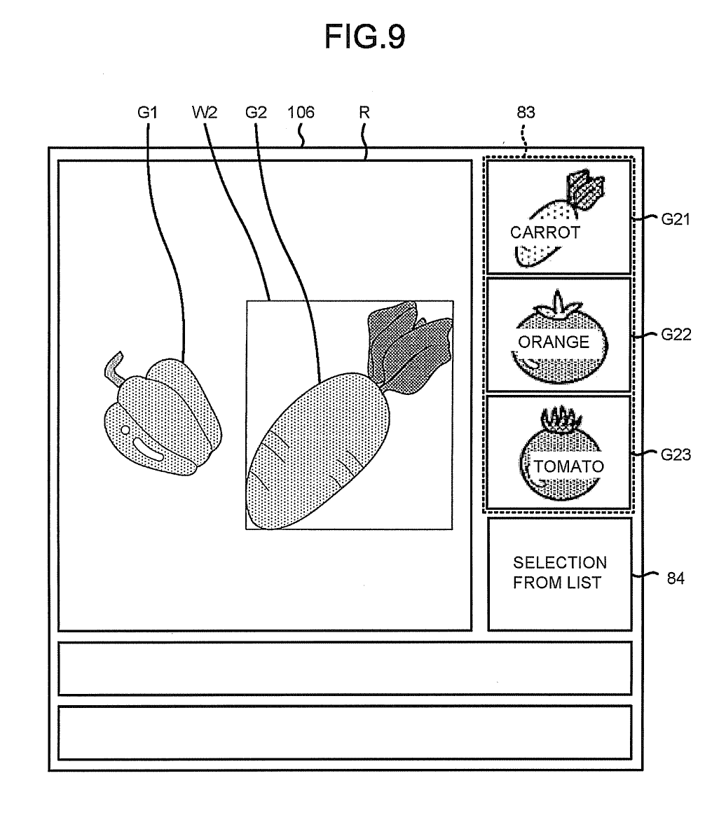

FIG. 8 and FIG. 9 are drawings showing an example of displaying a display picture of the selected image region. In the condition that the commodity G1 is selected from the commodities G1 and G2 in such a format in FIG. 6, the image region selection section 53 reports the commodity G1 as the target subjected to image recognition processing to the operator by displaying a frame W1 surrounding the image region A1 of the commodity G1. Moreover, in the condition that the commodity G2 is selected from the commodities G1 and G2 in such a format in FIG. 7, the image region selection section 53 reports the commodity G2 as the target subjected to the image recognition processing to the operator by displaying a frame W2 surrounding the image region A2 of the commodity G2.

In addition, so long as the W1 and the W2 can definitely show that the commodity G1 or the commodity G2 is selected uniquely, their shapes, display positions, sizes and colors are not limited particularly, and a frame in a shape other than a rectangle, such as the circular shape, the elliptical shape and the like can be utilized. Moreover, the size of the frame can be bigger than that of the selected image region and also can be smaller than that of the image region. Moreover, the selected image region can be displayed by a measure other than the frame, and the position where the selected image region is positioned also can be displayed by utilizing the mark such as an arrow and the like, and the like. Moreover, the selected image region further can be displayed by changing the luminosities, the colors, the contrasts and the like of the selected image region and a region other than the selected image region. In addition, the selected image region also can be displayed by combining these measures.

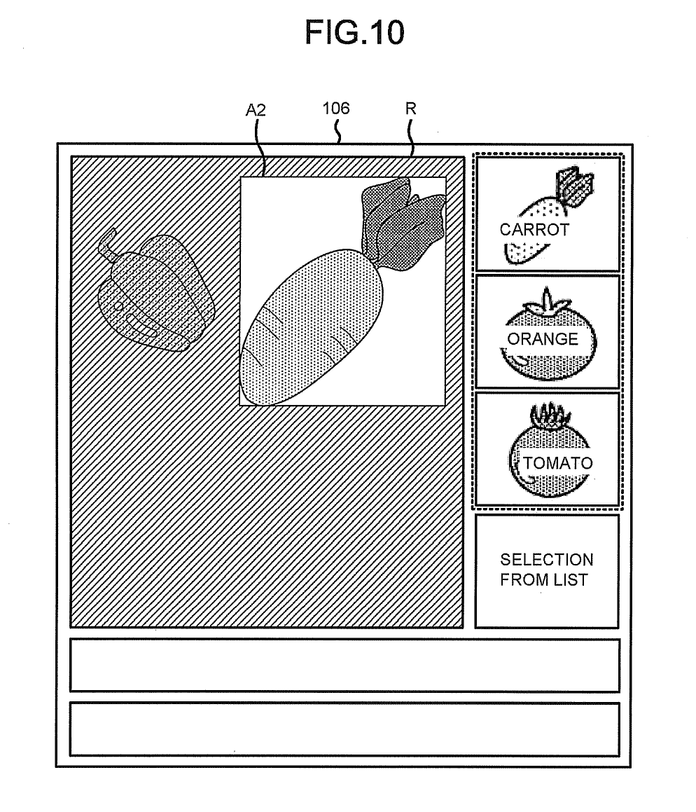

FIG. 10 is a drawing showing a picture example when the selected image region is displayed with different luminosities. As shown in FIG. 10, the image region selection section 53 displays the selected image region A2 and other regions in the frame image R with different luminosities, so that the regions other than the image region A2 are grayed out. Thus, the selected image region A2 can be displayed observably, so as to clearly identify the selected region.

The similarity calculation section 54 reads a surface state such as the hue, the surface concave-convex status and the like of the commodity G as the characteristic quantity according to all or part of the images of the commodities G included in the image region selected by the image region selection section 53. In addition, in order to shorten processing time, the similarity calculation section 54 does not consider the contour and the size of the commodity G.

The similarity calculation section 54 reads the surface state such as the hue, the surface concave-convex status and the like of a registered commodity as the characteristic quantity according to the commodity image of each commodity (called as the registered commodity hereinafter) registered in the PLU file F1, and calculates the similarity of the commodity G and the commodity registered in the PLU file F1 by comparing the read characteristic quantity with the characteristic quantity of the commodity G respectively. Herein, the similarity represents the degree with which all or part of the images of the commodity G are similar in the condition that the commodity image of each commodity stored in the PLU file F1 is set to be 100%=“similarity: 1.0”. In addition, for instance, for the concave-convex statuses of an interface and a surface, the similarity can be calculated by changing weighting.

In this way, a method recognizing an object included in the image is normally called as generic object recognition. About the generic object recognition, various recognition technologies are explicated in the following literature.

Yanai Keiji, “present state and perspectives of generic object recognition”, collected papers of information processing society, Vol. 48, No. SIG16 [retrieved on Heisei Aug. 10, 22], Internet <URL:http://mm.cs.uec.ac.jp/IPSJ-TCVIM-Yanai.pdf>.

Moreover, a technology carrying out the generic object recognition by carrying out region segmentation on the image according to a goal is explicated in the following document.

Jamie Capturedton and the like, “Semantic Texton Forests for Image Categorization and Segmentation”, [retrieved on Heisei Aug. 10, 22], Internet <URL:http://citeseerx.ist.psu.edu/viewdoc/download?doi=10.1.1.145.3036&rep=repl&type=pdf>.

In addition, a method calculating the similarity of the image of the captured commodity G and the commodity image of the registered commodity registered in the PLU file F1 is not particularly limited. For instance, the similarity of the image of the captured commodity G and each registered commodity registered in the PLU file F1 can be calculated as absolute evaluation and also can be calculated as relative evaluation. In the condition that the similarity is calculated as the absolute evaluation, the image of the captured commodity G is compared with each registered commodity registered in the PLU file F1 one by one, and the similarity educed from a comparison result is directly adopted. Moreover, in the condition that the similarity is calculated as the relative evaluation, if five registered commodities (commodities GA, GB, GC, GD and GE) are registered in the PLU file F1, the similarities of the captured commodity G are calculated to be 0.6 relative to the commodity GA, 0.1 relative to the commodity GB, 0.1 relative to the commodity GC, 0.1 relative to the commodity GD, 0.1 relative to the commodity GE, and the like, and the sum of the similarities relative to each registered commodity is 1.0 (100%).

The commodity candidate prompt section 55 displays a candidate (called as commodity candidate hereinafter) of the commodity G captured by the image capturing section 164 on the display 106 based on the similarity calculated by the similarity calculation section 54. More particularly, the commodity candidate prompt section 55 uses the registered commodity whose similarity reaches above a fixed value as the commodity candidate. Moreover, the illustration image and the commodity name of the registered commodity are read out from the PLU file F1 and are displayed in sequence on the display picture of the display 106 according to a sequence from a high similarity to a low similarity.

In this way, the similarity calculation section 54 and the commodity candidate prompt section 55 exerts functions as the commodity recognition section, that is, the commodity captured by the image capturing section 164 is recognized based on the similarity of the image of the target included in the image region selected by the image region selection section 53 and the commodity image of the registered commodity.

As shown in FIG. 8 and FIG. 9, a commodity candidate prompt region 83 for prompting the commodity candidate is installed near the display region of the frame image R. In the commodity candidate prompt region 83, the illustration image or the commodity image of the commodity candidate is displayed according to the commodity image included in the selected image region and the sequence of the registered commodity from the high similarity to the low similarity.

That is, in FIG. 8, the illustration images G11, G12 and G13 and each commodity name of the commodity candidate are displayed according to the sequence of the registered commodity from the high similarity to the low similarity with the image of the commodity G1 selected by the frame W1. In FIG. 9, the illustration images G21, G22 and G23 and each commodity name of the commodity candidate are displayed according to the sequence of the registered commodity from the high similarity to the low similarity with the image of the commodity G2 selected by the frame W2. These illustration images G11-G13 (refer to FIGS. 3) and G21-G23 (refer to FIG. 9) are formed to be capable of being selected corresponding to the selection operation of the touch panel 105. Moreover, a selection button 84 for selecting the commodity from a commodity list is installed at the lower part of the commodity candidate prompt region 83, and the commodity selected from the commodity list is processed as the commodity to be subjected to the sales registration.

In FIG. 8 and FIG. 9, an example that three commodity candidates as the commodity candidates of the commodities G1 and G2 are displayed each time is shown, but the number and the display method of the commodity candidates are not particularly limited. Moreover, the illustration image also can be replaced to display the commodity image (photo).

The input acceptance section 56 accepts various input operations corresponding to the display of the display 106 through the touch panel 105 or the keyboard 107. Moreover, the input acceptance section 56 accepts the selection operation on any one commodity candidate in the commodity candidates displayed by the display 106. The input acceptance section 56 accepts the selected registered commodity as the commodity corresponding to the commodity G.

The information output section 57 outputs the information (such as the commodity ID, the commodity name, the image file name of the selected commodity image, and the like) showing the commodity to the POS terminal 11 from the connection interface 175 aiming at the commodity accepted by the input acceptance section 56.

The information output section 57 also can output a sales number additionally input from the touch panel 105 or the keyboard 107 together with the commodity ID and the like to the POS terminal 11. Moreover, as the information output from the information output section 57 to the POS terminal 11, the commodity ID read out from the PLU file F1 by the information output section 57 can be directly notified, the file name and the commodity name of the commodity image which can specify the commodity ID also can be notified, and the storage location (storage address in the PLU file F1) of the commodity ID further can be notified to the POS terminal 11.

The sales registration section 611 of the POS terminal 11 carries out the sales registration of the corresponding commodity based on the commodity ID and the sales number output from the information output section 57. Particularly, the sales registration section 611 records the notified commodity ID, the commodity classification, the commodity name, the unit price and the like corresponding to the commodity ID and the sales number together in the sales master file and the like with reference to the PLU file F1, so as to carry out the sales registration.

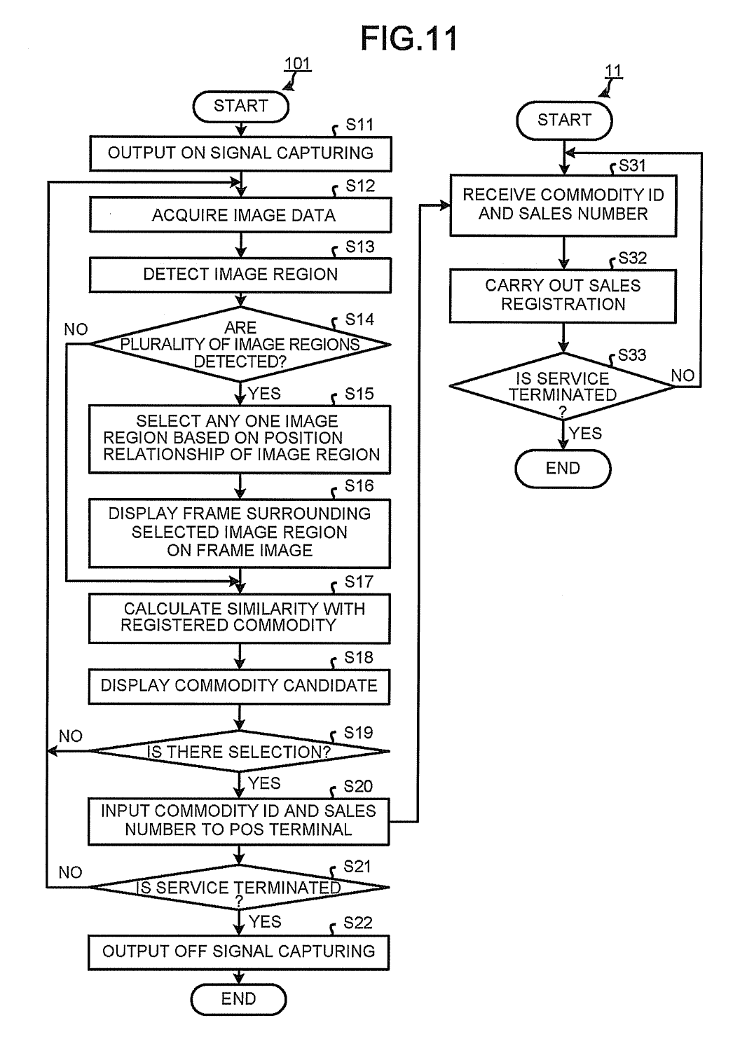

Next, the operations of the checkout system 1 are described in detail. FIG. 11 is a flow chart showing an example of the operations of the checkout system 1.

First, the operations of the commodity reading apparatus 101 are described. When the processing begins corresponding to that the POS terminal 11 begins commodity registration and the like, the image acquirement section 51 outputs a capturing-on signal to the image capturing section 164, so that the image capturing section 164 begins capturing (Act S11).

The image acquirement section 51 acquires the frame image R stored in the RAM 163 after being captured by the image capturing section 164 (Act S12). Subsequently, the image region detection section 52 detects the image region including all or part of the commodities G included in the frame image R acquired by the image acquirement section 51 (Act S13).

The image region selection section 53 judges whether or not the plurality of image regions are detected (Act S14). In the condition that one image region is only detected (Act S14: No), the processing is turned to Act S17. In the condition that the plurality of image regions are detected (Act S14: Yes), the image region selection section 53 selects any one image region based on the position relationship of the image regions (Act S15). Moreover, the image region selection section 53 displays the frame surrounding the image region selected in Act S15 on the frame image R (refer to FIG. 9) (Act S16).

Subsequently, in the condition that one image region is judged to be only detected in Act S14 (Act S14: No), the similarity calculation section 54 calculates the similarity of the commodity included in one image region and the registered commodity (Act S17). Moreover, in the condition that the plurality of image regions are judged to be detected in Act S14 (Act S14: Yes), the similarity calculation section 54 calculates the similarity of the commodity included in one image region selected in Act S15 and the registered commodity (Act S17).

Afterwards, the commodity candidate prompt section 55 re-sequences the commodity image and the commodity name of the registered commodity as the commodity candidate according to the sequence from the high similarity to the low similarity based on the similarity calculated in Act S17, and displays the commodity image and the commodity name on the commodity candidate prompt region 83 (refer to FIG. 9) (Act S18).

The input acceptance section 56 judges whether or not the selection operation of the commodity image of the registered commodity is accepted (Act S19). In the condition that the selection is not accepted (Act S19: No), the processing is turned to Act S12. In the condition that the selection is accepted (Act S19: Yes), the input acceptance section 56 judges the selected registered commodity as the commodity to be subjected to the sales registration. Subsequently, the information output section 57 outputs the commodity ID and the like of the registered commodity selected in Act S19 together with the sales number additionally input through the keyboard 107 to the POS terminal 11 (Act S20).

The CPU 161 judges whether or not the POS terminal 11 gives a termination notice about the commodity registration and the like to terminate a service (Act S21). In the condition of continuing the service (Act S21: No), the CPU 161 returns the processing to Act S12 to continuously execute the processing. In the condition of terminating the service (Act S21: Yes), the image acquirement section 51 outputs a capturing-off signal to the image capturing section 164, terminates the capturing of the image capturing section 164 (Act S22), and terminates the processing.

In Act S20, the input of the sales number is accepted through the keyboard 107, but a method inputting the sales number is not patricianly limited. For instance, the touched times of the selected image region also can be accepted as the sales number.

The operations of the POS terminal 11 are described. First, when the processing begins corresponding to the beginning of the commodity registration and the like according to the operation indication of the keyboard 22, the CPU 61 receives the commodity ID and the sales number of the determined commodity output from the commodity reading apparatus 101 in Act S20 (Act S31). Subsequently, the sales registration section 611 reads out the commodity category, the unit price and the like from the PLU file F1 based on the commodity ID and the sales number received in Act S31, and registers the sales information of the commodity G read by the commodity reading apparatus 101 in the sales master file (not shown in the figures) (Act S32). Subsequently, the CPU 61 judges whether or not to give the termination notice about the sales registration and the like by the operation indication of the keyboard 22 to terminate the service (Act S33). In the condition of continuing the service (Act S33: No), the CPU 61 returns the processing to Act S31 again to execute the processing continuously. In the condition of terminating the service (Act S33: Yes), the CPU 61 terminates the processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For instance, a method selecting one image region from the plurality of image regions is not limited to the example, and other methods also can be used. As an example, the image region selection section 53 selects one image region from the plurality of image regions by comparing the image data in the image regions, such as the luminosities and the like of the image regions (A1, A2 and the like). Moreover, a comparison method or a parameter and the like used in the comparison method can be selected or altered by a user.

Moreover, as the target in the description, the image region including all or part of the commodities is detected, but the target is not limited to the commodity. For instance, in the condition that the hand of the operator is captured as other target and in the condition that the target is judged to be the hand based on the similarity, the image region selection section 53 can select one target from the image region other than the image region including the hand.

The formation of each display picture is not limited to the examples in FIG. 8 and FIG. 9, and a display region displaying other elements and an operation button also can be installed.

In this embodiment, the form that the POS terminal 11 comprises the PLU file F1 is set, but is not limited to that, the form that the commodity reading apparatus 101 comprises the PLU file F1 also can be available, and the form that an external apparatus which can be accessed by the POS terminal 11 and the commodity reading apparatus 101 comprises the PLU file F1 further can be available.

The commodity reading apparatus 101 in this embodiment has the functions of the similarity calculation section 54, but is not limited to that, and the form that the POS terminal 11 has the functions of the similarity calculation section 54 and outputs the calculation result of the similarity to the commodity reading apparatus 101 further can be available.

In this embodiment, the construction of the POS terminal 11 and the commodity reading apparatus 101 is set, but is not limited to that, and one apparatus comprising the functions of the POS terminal 11 and the commodity reading apparatus 101 can be installed.

The program executed by each apparatus of the embodiment is provided by being previously programmed a storage medium (ROM or storage section) of each apparatus, but is not limited to that, and can be provided by being recorded in a computer-readable recording medium such as a CD-ROM, a floppy disk (FD), a CD-R, a DVD (Digital Versatile Disk) and the like by a file in an installable form or an executable form. In addition, the storage medium is not limited to a medium independent from a computer or an embedded system, and also includes the storage medium storing or temporarily storing the program after the program transmitted through an LAN, the Internet and the like is downloaded.

The program executed by each apparatus of the embodiment further may be stored in a computer connected with a network such as the Internet and provided by downloading through the network, or further may be provided or distributed through the network such as the Internet and the like.

As described above, according to the embodiment, in the condition that the plurality of targets are detected in the frame image, any one target is selected, and the commodity recognition is carried out on the target. Therefore, even though in the condition that the plurality of targets are detected, the plurality of targets also can be reduced to one target to carry out the recognition processing, so that the information processing apparatus and the program which can lighten the load of the recognition processing can be provided.

What is claimed is:

1. An information processing apparatus, comprising:
an acquirement section configured to acquire an image captured by an image capturing section;
a detection section configured to detect all or part of targets included in the image acquired by the acquirement section;
a selection section configured to select any one target in the condition that the detection section detects a plurality of targets;
a display control section configured to display the target selected by the selection section in the plurality of targets on the image acquired by the acquirement section; and
a commodity recognition section configured to recognize a commodity captured by the image capturing section based on a similarity showing a degree with which all or part of the images of the target selected by the selection section are similar to the reference image of each commodity.

2. The information processing apparatus according to claim 1, wherein
the detection section detects an image region including all or part of the targets;
the selection section selects any one image region based on the position of the image region in the image acquired by the acquirement section in the condition that a plurality of image regions are detected; and
the commodity recognition section recognizes the commodity captured by the image capturing section based on the similarity of the image of the target included in the image region selected by the selection section and the reference image.

3. The information processing apparatus according to claim 2, wherein
the selection section selects any one image region based on the luminosity of each image region acquired by the acquirement section.

4. The information processing apparatus according to claim 2, wherein
the display control section displays a frame including the image region selected by the selection section on the image acquired by the acquirement section.

5. The information processing apparatus according to claim 1, wherein
the commodity recognition section recognizes a candidate of the commodity captured by the image capturing section based on the similarity of one target selected by the selection section and the reference image; and
the display control section displays the target which is selected by the selection section on the image acquired by the acquirement section, and displays information relevant with the candidate of the commodity recognized by the commodity recognition section in order of the similarity.

6. A method, comprising:
acquiring an image captured by an image capturing section;
detecting all or part of targets included in the image acquired by an acquirement section;
selecting any one target in the condition that a detection section detects a plurality of targets;
displaying the target selected by a selection section in the plurality of targets on the image acquired by the acquirement section; and
recognizing a commodity captured by the image capturing section based on a similarity showing a degree with which all or part of the images of the target selected by the selection section are similar to the reference image of each commodity.
